(19) United States
(12) Patent Application Publication
(10) Pub. No.: US 2004/0253370 A1
(43) Pub. Date: Dec. 16, 2004

(54) Synthetic suede leather and a process for preparing the same

(76) Inventor: Werner Hoersch, Viersen (DE)

Correspondence Address: MILLIKEN & COMPANY, 920 MILLIKEN RD, PO BOX 1926, SPARTANBURG, SC, 29304, US

(21) Appl. No.: 10/482,557

(22) PCT Filed: Jul. 3, 2002
(86) PCT No.: PCT/EP02/07384

(30) Foreign Application Priority Data
Jul. 4, 2001 (DE) 101 32 255.0

(51) Int. Cl. B05D 1/18; B32B 27/04; D06C 5/00; B05D 3/12; D06C 3/00

(52) U.S. Cl. 427/175; 427/176; 427/434.6; 428/904; 442/104

(57) ABSTRACT

The present invention relates to a process for preparing a synthetic suede leather, a synthetic suede leather obtainable by said process and the use of said synthetic suede leather as a cover in automotive and furniture applications or as outer garments. The process comprises the steps of (a) foaming a composition comprising an aqueous polyurethane dispersion; (b) applying the foamed composition to a textile substrate composed of a yarn; (c) coagulating the polyurethane dispersion; (d) drying; and (e) condensation said foamed composition containing pigments during application. The textile substrate is preferably pre-dyed with disperse dyes.

The present invention relates to a process for preparing a synthetic suede leather, a synthetic suede leather obtainable by said process and the use of said synthetic suede leather as a cover in automotive and furniture applications or as outer garments.

Conventional suede leathers may be obtained by impregnating a textile substrate with a polyurethane solution, coagulating the polyurethane and subsequent sueding of the surface. In doing so, the size of the fibres constituting the synthetic suede are reduced to a micro-fine denier level in order to obtain a synthetic suede leather of excellent appearance. Especially in micro-fine denier fibres, however, the problem occurs that they provide insufficient light-fastness and colour stability after dyeing. Therefore, such synthetic suede leathers were dyed with disperse dyes only after coagulation of the polyurethane. However, this dye is also insufficient with regard to light-fastness and colour stability for many areas of application e.g. covers for automotive applications. Therefore, attempts have been made to further improve the colour development characteristics of synthetic suede leathers.

EP 0 651 090 B1, for example, describes a suede-like synthetic leather the substrate of which is composed of fibre bundles of fine fibres and micro-fine fibres and an elastomer polymer, wherein said fine and micro-fine fibres are distributed approximately uniformly over the cross-section of the fibre bundles, the fibre bundles in the interstices between the individual fibres making up each fibre bundle do not contain the elastomer polymer, the substrate has a pile of fibre bundles on its surface and is dyed, the leather being characterised in that the fibre bundles constituting the substrate are composed of fine fibres having a count of 0.02 to 0.2 denier and micro-fine fibres having a count of not more than 1/5 of the mean count of the fine fibres and less than 0.02 denier, the ratio between the number of fine fibres and the number of micro-fine fibres being in the range of 2:1 to 2:3 and the ratio between the number of fine fibres and the number of micro-fine fibres at the outer surface of the pile being at least 3:1. If such a defined non-woven fabric is impregnated with an elastomer polymer and coagulated and a regular dyeing process is then conducted afterwards, a suede-like synthetic leather having improved colour development characteristics is obtained in accordance with EP 0 651 090 B1.

U.S. Pat. No. 5,876,466, on the other hand, discloses the preparation of a synthetic suede leather with improved colour stability where a textile substrate impregnated with polyurethane is first subjected to dyeing with disperse sulfur dyes, vat dyes, and sulfur vat dyes and then treated with 2,2′,4,4′-tetrahydroxy benzophenone.

Against this background, it is the object of the present invention to provide a synthetic suede leather which has a pleasant appearance and good feel as well as excellent colour stability and light-fastness, and a process for preparing such a leather.

The invention solves this problem by a process for preparing a synthetic suede leather comprising the steps of

(a) foaming a composition comprising an aqueous polyurethane dispersion;

(b) applying the foamed composition to a textile substrate composed of a yarn;

(c) coagulating the polyurethane dispersion;

(d) drying; and

(e) condensation,

said foamed composition containing pigments during application.

The invention further provides a synthetic leather obtainable by this process.

The polyurethane dispersion to be used according to the invention is not particularly limited as long as it is a waterborne dispersion, the term “polyurethane” also comprising polyurethane polyureas. A survey of polyurethane (PUR) dispersions and processes therefor may be found in Rosthauser & Nachtkamp, “Waterborne Polyurethanes, Advances in Urethane Science and Technology”, vol. 10, pages 121-162 (1987). Suitable dispersions, for example, are also described in “Kunststoffhandbuch”, vol. 7, 2^{nd} ed., Hanser, pages 24 to 26. Preferably, the polyurethane dispersions used according to the invention are polyurethane dispersions suitable for post-curing.

Constituent components of the dispersions used according to the invention may be:

1) Organic di- and/or polyisocyanates such as tetramethylene diisocyanate, hexamethylene diisocyanate (HDI), 2-methyl-pentamethylene diisocyanate, 2,2,4-trimethylhexamethylene diisocyanate (THDI), dodecane methylene diisocyanate, 1,4-diisocyanato cyclohexane, 3-isocyanatomethyl-3,3,5-trimethyl cyclohexyl isocyanate (isophorone diisocyanate=IPDI), 4,4′-diisocyanato dicyclohexyl methane (®Desmodur W), 4,4′-diisocyanato-3,3′-dimethyl dicylohexyl methane, 4,4′-diisocyanato dicyclohexyl propane-(2,2), 1,4-diisocyanato benzene, 2,4- or 2,6-diisocyanato toluene or mixtures of these isomers, 4,4′-, 2,4′- or 2,2′-diisocyanato diphenyl methane or mixtures of these isomers, 4,4′- , 2,4′- or 2,2′-diisocya-nato diphenyl propane-(2,2)-p-xylylene diisocyanate and [symbol] , [symbol] , [symbol] ′, [symbol] ′-tetramethyl-m or -p-xylylene diisocyanate (TMXDI) as well as mixtures consisting of these compounds. For purposes of modification, small amounts of trimers, urethanes, biurets, allophanates or uretdions of the above mentioned diisocyanates may be used. MDI Desmodur W, HDI and/or IPDI are particularly preferred.

2) Polyhydroxyl compounds having 1 to 8, preferably 1,7 to 3,5 hydroxyl groups per molecule and a (mean) molecular weight of up to 16,000, preferably up to 4,000. Both defined low-molecular polyhydroxyl compounds such as ethylene glycol, 1,2-, 1,3-propylene glycol, 1,4-butadiol, 1,6-hexadiol, neopentyl glycol, trimethylol propane, glycerine, the reaction product of 1 hydrazine+2 propylene glycol and oligomer or polymer polyhydroxyl compounds having molecular weights of 350 to 10,000, preferably 840 to 3,000 may be contemplated.

Higher molecular hydroxyl compounds comprise the hydroxy polyesters, hydroxy polyethers, hydroxy polythioethers, hydroxy polyacetates, hydroxy polycarbonates and/or hydroxypolyester amides per se known in polyurethane chemistry, preferably those having mean molecular weights of 350 to 4,000, especially preferably those having mean molecular weights of 840 to 3,000. Hydroxy polycarbonates and/or hydroxy polyethers are particularly preferred. By using them, coagulates of particular stability to hydrolysis may be prepared.

3a) Ionic or potentially ionic hydrophilising agents having an acid group and/or an acid group present in form of a salt and at least one isocyanate-reactive group, e.g. OH or NH2 group. Examples are the Na salt of the ethylene diamine-β-ethyl sulfonic acid (AAS salt solution), dimethylol propionic acid(s) (DMPA), dimethylol butyric acid, aliphatic diols comprising aliphatic diols according to DE-A-24 46 440, hydroxy pivalic acid or adducts of 1 mol of diamine, preferably isophorone diamine, and 1 mol of an [symbol] ,β-unsaturated carboxylic acid, preferably acrylic acid (see German patent application 197 50 186.9). Hydrophilising agents of the latter type containing carboxylate and/or carboxyl groups or of dimethylol propionic acid are preferred.

3b) Non-ionic hydrophilising agents in the form of mono- and/or difunctional polyethylene oxide or polyethylene propylene oxide alcohols having molecular weights of 300 to 5000. Especially preferred are n-butanol-based monohydroxy-functional ethylene oxide/propylene oxide polyethers having 35 to 85 wt.-% of ethylene oxide units and a molecular weights of 900 to 2,500. A content of at least 3, especially at least 6 wt.% of non-ionic hydrophilising agents is preferred.

4) Blocking agents for isocyanate groups such as oximes (acetone, butanone or cyclohexanone oxime), secondary amines (diisopropyl amine, dicyclohexyl amine), NH-acidic heterocyclic substances (3,5-dimethyl pyrazole, imidazole, 1,2,4-triazole), CH-acidic esters (malonic acid-C₁-C₄ alkyl ester, acetic acid ester) or lactames ( [symbol] -caprolactame). Butanone oxime, diisopropyl amine and 1,2,4-triazole are especially preferred.

5) Polyamines as incorporated chain extenders to provide the polymer backbone of the post-curable dispersions specific properties. For example, these include the polyamines discussed under 6) below. The diamino-functional hydrophilising agents discussed under 3a) are also suitable as incorporated chain extenders. Ethylene diamine, IPDA and H₁₂MDA are especially preferred.

6) Polyamine crosslinking agents for post-curing under heat. These are preferably aliphatic or cycloaliphatic diamines, even though trifunctional polyamines or polyamines with higher functions may optionally be used in order to achieve specific characteristics. In general, it is possible to use polyamines having additional functional groups, e.g. OH-groups. The polyamine crosslinking agents which are not incorporated into the polymer backbone at normal to slightly elevated ambient temperatures, e.g. 20 to 60° C., may be admixed either immediately upon preparation of the reactive dispersions or at any subsequent point in time. Examples of suitable aliphatic polyamines are ethylene diamine, propylene diamine-1,2 and -1,3, tetramethylene diamine-1,4, hexamethylene diamine-1,6, the isomer mixture of 2,2,4- and 2,4,4-trimethyl hexamethylene diamine, 2-methyl pentamethylene diamine and bis-(β-aminoethyl) amine (diethylene triamine).

The constituent components enumerated above are present in the reactive dispersions in the following preferred ranges, the addition of all six components resulting in 100 wt.-% solids content of a dispersion:

| | | |
|---|---|---|
| 1) | Polyisocyanates | 9.0 to 30.0 wt.-% |
| | Especially preferred | 13.0 to 20.0 wt.-% |
| 2) | Polyhydroxy compounds | 40.0 to 85.0 wt.-% |
| | Especially preferred | 55.0 to 75.0 wt.-% |
| 3a) | Ionic hydrophilising | 0.0 to 5.0 wt.-% |
| | agent | |
| | Especially preferred | 2.5 to 4.0 wt.-% |
| 3b) | Non-ionic | 0.0 to 17.0 wt.-% |
| | hyd\ddot{r}ophilising agent | |
| | Especially preferred | 6.0 to 12.0 wt.-% |
| 4) | Blocking agent | 0.0 to 5.0 wt.-% |
| | Especially preferred | 1.5 to 4.0 wt.-% |
| 5) | Chain-extending | 0.0 to 5.0 wt.-% |
| | polyamine | |
| | Especially preferred | 0.0 to 1.5 wt.-% |
| 6) | Polyamine crosslinking | 0.0 to 6.0 wt.-% |
| | agent | |
| | Especially preferred | 2.0 to 4.0 wt.-% |

The solids content of the PUR dispersion used is preferably at least 40 wt.-%, more preferably at least 50 wt.-% and especially at least 65 wt.-%.

PUR dispersions preferably used in the invention are described in DE 198 56 412 Al. PUR dispersions preferably used in the invention include Tubicoat PU80 (manufacturer/supplier: CHT R. Beitlich GmbH, Tübingen), Witcobond W-293 (67% solids content) and Millikogate 1200 (Milliken, U.S.A.).

According to the invention, the composition comprising the PUR dispersion contains pigments when applied to the textile substrate, which pigments may be added both before and after foaming, preferably before foaming. Pigments used in the invention are described in Ullmann's Encyclopedia of Industrial Chemistry, 5^{th ed.,} 1992, vol. A20, pages 243 to 413. The pigments used in the invention may be inorganic or organic pigments. The light-fastness of the pigments used should be as high as possible and is preferably in the range of the light-fastness of the pigments Bezaprint, e.g. Bezaprint Gelb RR (yellow), Bezaprint Grün B (green), Bezaprint Rosa BW (pink), Bezaprint Braun TT (brown), Bezaprint Violett FB (purple), Bezaprint Rot KGC (red), Bezaprint Blau BT (blue) and Bezaprint Blau B2G (blue) (all available from Bezema AG, Montlingen, Switzerland), PIGMATEX Gelb 2 GNA (60456), PIGMATEX Gelb K (60455), PIGMATEX Fuchsia BW (60416), PIGMATEX Marine RN (60434), PIGMATEX Braun R (60446), PIGMATEX Schwarz T (60402) (all available from SUNChemical, Bad Honnef, Germany), Oker E.M.B. (Ref. 3500), Rot-Violett E.M.B.(Ref. 4406), Braun E.M.B.(Ref. 5550), und Blau E.M.B. (Ref. 6500) (all available from EMB NR, Bronheim, Belgieum), which are especially preferred for the invention. The light-fastness values are preferably at least 6, more preferably at least 7 (blue scale; 1 g/kg, see DIN 75 202). The amount of pigments used depends on the intended depth of the colour and is not particularly limited. Preferably, the pigment is used in an amount of up to 10 wt.-% based on the total weight of the composition, especially preferably in an amount of 0.1 to 5 wt.-%.

In addition, a composition used in the invention preferably contains one or more substances which, as a rule, ensure uniform coagulation of the polyurethane when the temperature is raised. This substance, the coagulant, usually is a salt or an acid causing coagulation of the polyurethane under certain conditions such as a certain temperature, for example ammonium salts of organic acids such as Tubicoat-Koagulant AE 24% (available from CHT R. Beitlich GmbH, Tütbingen). These substances also comprise an acid-generating chemical agent, i.e. a substance which is not an acid at room temperature, but turns into an acid after heating. Specific examples for such compounds include ethylene glycol diacetate, ethylene glycol formate, diethylene glycol formate, triethyl citrate, monostearyl citrate and an organic acid ester available from Highpoint Chemical Corporation under the trade name Hipochem AG-45. The coagulant is preferably present in the composition in an amount of 1 to 10 wt.-% based on the solids content of the polyurethane dispersion.

In addition, the composition used according to the invention may contain a surfactant which, when heated, is less water-soluble than at room temperature. Such a surfactant binds to the polyurethane latex upon gelation and facilitates the uniform coagulation of the latex over the entire surface of the textile substrate over which it is applied. Specific surfactants meeting these requirements include polyethylene oxides, poly(ethylene/propylene) oxides, polythioethers, polyacetales, polyvinyl alkyl ethers, organopolysiloxanes, polyalkoxylated amines and derivatives of such compounds, polyalkoxylated amines available from Clariant under the trade name Catafix U® being preferred.

In accordance with the invention, the substances for coagulation and the pertinent process steps for coagulation as described in U.S. Pat. No. 5,916,636, U.S. Pat. No. 5,968,597, U.S. Pat. No. 5,952,413 and U.S. Pat. No. 6,040,393 may be used.

In addition, the composition used according to the invention preferably contains a foaming agent, generally a surfactant, preferably a non-ionic surfactant such as alkyl amine oxide, or an anionic surfactant, such as ammonium stearate, e.g. the foamer Tubicoat AOS from CHT R. Beitlich GmbH, Tübingen. The amount of the foaming agent used is selected in such a manner that a foam is provided which remains stable after application to the textile substrate, preferably until coagulation. In general, the amount is 0.01 to 10 wt.-%, preferably 1 to 10 wt.-% based on the solids content of the polyurethane dispersion.

Furthermore, the composition of the invention may contain foam stabilisers. Known compounds may be used as foam stabilisers (B), for example water-soluble fatty acid amides, hydrocarbon sulfonates or saponaceous compounds (fatty acid salts), for example compounds wherein the lipophilic radical contains 12 to 24 carbon atoms; especially alkane sulfonates having 12 to 22 carbon atoms in the hydrocarbon radical, alkyl benzosulfonates having 14 to 24 carbon atoms in the entire hydrocarbon radical or fatty acid amides or saponaceous fatty acid salts of fatty acids having 12 to 24 carbon atoms. The water-soluble fatty acid amides are preferably fatty acid amides of mono- or di- (C2-3-alkanol) amines. For example, the saponaceous fatty acid may be an alkali metal salt, amine salt or unsubstituted ammonium salt. Known compounds are generally considered as fatty acids, such as lauric acid, myristic acid, palmitic acid, oleic acid, stearic acid, ricinoleic acid, behenic acid or arachic acid, or technical fatty acids such as coconut fatty acid, tallow fatty acid, soy fatty acid or technical oleic acid as well as hydrogenation products thereof. Especially preferred are unsubstituted ammonium salts of higher saturated fatty acids, especially those having 16 to 24 carbon atoms, primarily stearic acid and hydrogenated tallow fatty acid. The foam stabilisers should be of the kind which decompose neither under foaming conditions nor under application conditions. Suitable ammonium salts are those having a decomposition temperature of ≧90° C., preferably ≧100° C. If desired, the more weakly anionic stabilisers (B₁), especially the carboxylic salts or the amides, may be combined with the more strongly anionic surfactants (B₂), especially with the above-mentioned sulfonates or preferably fatty alcohol sulfates, advantageously in the form of salts thereof (alkali metal or ammonium salts as mentioned above), for example at a (B₁)/(B₂) weight ratio in the range of 95/5 to 50/50, advantageously 85/15 to 65/35.

The composition used according to the invention preferably also contains plasticisers, thickening agents, fixing agents, emulsifiers, flame retardants and/or sunscreens.

Suitable plasticisers are the substances listed in A. K. Doolittle, “The Technology of Solvents and Plastizisers”, J. Wiley & Sons. Ltd. Polymer plasticisers are preferably used, for example Tubicoat MV (available from CHT R. Beitlich GmbH, Tübingen). The amount of plasticiser should be as low as possible in order to ensure good abrasion resistance of the final product. The plasticiser is preferably used in an amount of up to 10 wt.-% based on the total weight of the composition, more preferably 2 to 7 wt.-%.

Suitable thickening agents are common thickening agents such as polyacrylic acids, polyvinyl pyrrolidones or cellulose derivatives such as methyl cellulose or hydroxy ethyl cellulose, e.g. Tubicoat HEC (available from CHT R. Beitlich GmbH, Tübingen).

Fixing agents preferred for the invention are aminoplasts or phenolic resins. Suitable aminoplasts or phenolic resins are the well-known commercial products (cf. “Ullmanns Enzyklopadie der technischen Chemie”, vol. 7, 4^{th} edition, 1974, pages 403 to 422, and “Ullmann's Encyclopedia of Industrial Chemistry, vol. A19, 5^{th} ed., 1991, pages 371 to 384.

The melamine-formaldehyde resins are preferred, replacement of 20 mol-% of the melamine with equivalent amounts of urea being possible. Methylolated melamine is preferred, for example bi-, tri- and/or tetramethylol melamine.

The melamine-formaldehyde resins are generally used in powder form or in the form of their concentrated aqueous solutions which have a solids content of 40 to 70 wt.-%. For example, Tubicoat Fixierer HT (available from CHT R. Beitlich GmbH, Tübingen) may be used.

As emulsifiers, the composition used in the invention may contain alkyl sulfates, alkyl benzene sulfonates, dialkyl sulfosuccinates, polyoxyethylene alkyl phenyl ether, polyoxyethylene acyl ester and alkyl aryl polyglycol ether such as Tubicoat Emulgator HF (available from CHT R. Beitlich GmbH, Tübingen) or fatty acid salts in the form of their alkali or ammonium salts.

Suitable flame retardants are antimony trioxide Sb₂O₃, antimony pentoxide Sb₃O₃, alumina hydrate Al₂O₃.3H₂O, zinc borate Zn(BO₂)₂.2H₂O or 2ZnO.(B₂O₃)₃.(H₂O)_{3,5}, ammonium ortho- or polyphosphate NH₄H₂PO₄ or (NH₄PO₃)ₙ and chloroparaffines.

Especially preferred are the phosphonic acid esters, particularly 5-ethyl-2-methyl-1,3,2-dioxaphosphorinane-5-yl)methyl phosphonate-P-oxide and bis(5-ethyl-2-methyl-1,3,2-dioxaphosphorinane-5-yl)methyl methyl phosphonate-P,P′-dioxide.

Sunscreens such as bis(1,2,2,6,6-pentamethyl-4-piperidyl) sebacate and methyl-1,2,2,6,6-pentamethyl-4-piperidyl sebacate, UV absorbers and sterically hindered phenols may also be included in the composition used according to the invention.

The textile substrate of a yarn used according to the invention is not particularly limited. Especially preferred are yarns with fine filament yarns which preferably have an average titer of individual filaments of 2 denier or less, preferably 0.01 to 1.6 denier, and especially 0.6 to 1.4 denier.

Particularly useful yarns include for example flat or textured polyester yarns with filament titers of 0.6 denier to approximately 1.4 denier, e.g. flat or textured (e.g. false twist textured) polyester filament yarns. Moreover, yarns made of components having different shrinkage degrees may also be suitable to enhance the handle properties.

For yarns which do not contribute to the formation of the covering (appearance, handle properties) the titer is not relevant (see e.g. Example 2, guide bar 3).

Furthermore, textile substrates of micro-split yarn may be used, the micro-fibres preferably having a titer in the range of 0.01 to 0.4 denier, more preferably in the range of 0.08 to 0.25 denier. For example, the micro-fibres are prepared as follows. First a multi-component fibre of at least two polymers is formed by a process comprising mixing and melting the at least two polymers having low compatibility and mutual solubility and then spinning said molten mixture; or by a process comprising melting at least two polymers having no compatibility or mutual solubility and then combining them near a spinning jet and spinning them. In the multi-component fibre thus obtained, at least one polymer forms a disperse phase (“island component”, i.e. the micro-fibre component) and the other polymer forms the phase of the dispersing medium (“sea component”). The micro-fibres (“islands”) may consist of polyester such as polyethylene terephthalate, 6- or 6,6-polyamide cotton, cotton/polyester blends, wool, ramie or. Lycra, while the “sea” or the fibre jacket may be present in the form of a polystyrene, styrene copolymer, polyethylene, ethylene propylene copolymer, sodium sulfoisophthalic acid, copolymerised polyester matrix or a mixture thereof. The filaments may have the following characteristics: 1.4 to 10 denier, preferably 3.4 to 3.8 denier, stretch ratio 2:1 to 5:1, 4 to 15 crimps per cm. In addition, the filaments may contain 4 to 14 parts by weight of a micro-fibre, 20 to 50 parts by weight of matrix and, optionally, about 3 parts by weight of polyethylene glycol, the latter being contained in the matrix. As a rule, the filaments are processed into a felt which is then needled in order to obtain a needle-felt having a density of 0.15 to 0.35 g/cm³. The needle-felt is than immersed in a splitting bath, for example an aqueous solution of polyvinyl alcohol, a halogenated hydrocarbon or a 3% NaOH solution, depending on the nature of the “sea” component. The product obtained is dried and represents an example for a textile substrate used in accordance with the invention.

The textile substrate made of a yarn may be a woven fabric, a non-woven fabric, a knitted fabric or a warp-knit, the latter being preferred. Preferred textile substrates comprise the textile fabrics described in EP 0 584 511 B1 and EP 0 651 090 B1.

In accordance with the invention, it is preferred not to use an untreated white substrate in the process of the invention, but to pre-dye the textile substrate with disperse dyes. In automotive applications, disperse dyes for post-aging lightfast textiles are preferably used for this purpose, most preferably the dyes of the Trasin H® brand made by Ciba and the dyes of the Dorospers® brand made by Dohmen. The light-fastness of the disperse dyes used is preferably in the range of these branded dyes. The disperse dye is selected depending on the pigments used, the colour difference between the disperse dye and the pigment preferably being small or the disperse dye and pigment preferably having the same hue. In case of a red colouring, for example, both the disperse dye and the pigment will be red. This is advantageous, because it helps avoid a white underground of textile substrate appearing in case of local abrasion of the polyurethane layer. The disperse dye is preferably used in a concentration such that the depth of the colouring with the disperse dye is less than that of the pigment colouring. Therefore it is sufficient and, in view of the high cost of dyeing fibres, preferred to pre-dye the textile substrate grey, for example, in order to prepare black synthetic suede leather.

The individual steps of the process according to the invention are described in detail below.

The composition comprising the polyurethane dispersion and, optionally, the pigments is first foamed. For this purpose, the composition may be foamed mechanically. This may be carried out in a foam mixing device under application of high shear forces. Foaming in a foam generator by blowing in pressurised air is another alternative. A Stork mixer or a foam processor, e.g. the Stork FP3 foam processor, is preferably used. Foaming is carried out in such a manner that the foam density obtained is preferably 250 to 600 g/l, especially preferably 300 to 500 g/l.

The foamed composition is then applied to the substrate with common coating devices, for example a blade such as a doctor blade, rollers or other foam application devices. Blade devices, for example of the type described in EP 0 879 145 B1 or EP 0 828 610 B1, are preferred. The use of a closed squeegee system, preferably with an exchangeable squeegee blade such as the Stork Rotary Screen Coating Unit CFT is especially preferred. Application may be carried out on one side or both sides. The amount applied is selected in such a manner that the weight increase after condensation is at least 20%, preferably 30 to 40 %, based on the textile substrate, e.g. 33%. The amount applied per m² may be influenced via the pressure in the closed squeegee system or by the mesh number of the screen. The wet weight applied preferably corresponds to the weight of the textile substrate. The foam decomposition rate on the substrate depends on the type and amount of the foaming agent. Preferably, the foam collapses completely during the time span between application and steam coagulation, said time span depending on the distance to be covered in the device and the speed of the process.

The manner in which coagulation is effected depends largely on the chemical composition of the dispersion used in the invention and, particularly, on the type of coagulant if present. For example, coagulation may be carried out by evaporation coagulation or by salt, acid or electrolyte coagulation. As a rule, coagulation is effected by a temperature increase. For example, the composite material of a textile substrate and foam may be subjected to a short heating treatment with heated steam, for example 1 to 10 sec. at 100 to 110° C. This is especially preferred when ammonium salts of organic acids are used as coagulants. On the other hand, if the above-mentioned acid-generating chemicals are used as coagulants, coagulation preferably takes place in the manner described in U.S. Pat. No. 5,916,636, U.S. Pat. No. 5,968,597, U.S. Pat. No. 5,952,413 and U.S. Pat. No. 6,040,393, respectively.

After coagulation, drying and condensation is carried out. The drying may take place either at a temperature below the cross-linking temperature or at a temperature above the cross-linking temperature. In the latter case, the drying and condensation steps coincide.

If the drying and the condensation are carried out in separate steps, drying is firstly effected at a temperature below the cross-linking temperature, preferably below 140° C., more preferably at 80 to 100° C. Drying may be carried out in any conventional dryer. However, drying in a microwave (HF) dryer is preferred, since evaporation does not take place on the surface, but uniformly throughout the entire composite material, which counteracts the formation of a film on the surface.

Subsequently, the condensation is carried out in a temperature range above the cross-linking temperature, preferably at 140 to 200° C., more preferably at 165 to 175° C., contact time being selected in a manner to ensure sufficient condensation of the PU component.

Alternatively, drying and condensation in a single step may follow the coagulation by heating directly at a temperature above the cross-linking temperature, preferably at 140 to 200° C., more preferably at 165 to 175° C., contact time being selected in a manner to ensure sufficient drying and sufficient condensation of the PU component.

The dried textile substrates may be subjected to surface treatment before, during or after condensation, for example by sueding, raising and/or tumbling. It is particularly preferable to suede and, additionally, to perform a mechanical treatment in a tumbler (which may be either operated continuously or in batch mode) after the condensation step, since this may improve the handle and surface characteristics considerably.

Alternatively, it is especially preferred to conduct the condensation under mechanical stress, for example in a tumbler.

After condensation, the synthetic suede leather obtained may be subjected to post-treatment, the type of such post-treatment depending on the desired surface appearance. In case of a “peach skin” or similar surfaces, i.e. a very dense, but short pile, an sueding process is conducted, whereas a raising process-is conducted if a somewhat longer pile is desired.

After that, final stentering to a defined width is carried out.

The invention also provides a synthetic suede leather which may be obtained by the above-mentioned process and the use of the synthetic suede leather as a cover in automotive, upholstery and furniture applications or as outer garments.

### EXAMPLES

### Example 1

| | |
|---|---|
| Starting material: | 3-bar warp-knitted fabric |
| Guide bar 1: | 7.1 wt.-% of 33 f 16T616 Trevira (33 dtex in |
| | 16 single titres, type 616) |
| Guide bat 2: | 84.7 wt.-% of 160f 64 × 12 text (160 dtex in |
| | 64 single titres each of which may be |
| | splitted into 12 single titres by post- |
| | treatment, corresponding to a single titre |
| | of 0.208 dtex) |
| Guide bar 3: | 8.2 wt.-% as for guide bar 1. |

All yarns are undyed.

Path of Treatment:

1. 1× pre-raising on 7 tambour cylinders

2. 1× raising and shearing

3. Dyeing with selected disperse dyes as formulated

4. Drying

The textile substrate is now ready for coating (weight per unit area 300 g/m²).

Then a composition for application was prepared by mixing the following components (all in parts by weight).

| | |
|---|---|
| Tubicoat thickening agent HEC | 1 part |
| Tubicoat PU 80 | 744 parts |
| Tubicoat plasticiser MV | 100 parts |
| Tubicoat foamer AOS | 50 parts |
| Tubicoat fixing agent HT | 20 parts |
| Tubicoat coagulant 24% AE | 35 parts |
| Tubicoat emulsifier HF | 20 parts |
| Tinuvin (Ciba B 75) (special sunscreen | 20 parts |
| for polymers) | |
| Ammonia | 3 parts |
| Pigment preparation | 7 parts |
| Total | 1000 parts |

All of the products of the “Tubicoat” series are available from CHT R. Beitlich GmbH, Tübingen, Germany.

The following pigments are used depending on the intended hue:

Bezaprint Gelb RR (yellow)

Bezaprint Grün B (green)

Bezaprint Rosa BW (pink)

Bezaprint Braun TT (brown)

Bezaprint Violett FB (purple)

Bezaprint Blau B2G (blue)

The Bezaprint pigments are available from the following supplier: Bezema AG, CH-9462 Montlingen.

This coating liquid, the colour of which has been adjusted (with pigments of high light-fastness), is fed into a Stork FP 3 foam processor where an instable foam having a relative density of about 400 g/l is produced. Said foam is fed directly into a closed squeegee system of the Stork Rotary Screen Coating Unit CFT.

At a pressure of 2 bar in the closed squeegee system and a mesh number of the screen of 40, a overall weight per unit area of (textile substrate+coating) of 400 to 410 g/m² is obtained.

After application of the coating, the article is subjected. to a very brief, but intense steam treatment (about 4 sec. at 102° C.) which causes spontaneous coagulation. After coagulation, the article is pre-dried at a temperature below the cross-linking temperature of 140° C. at 90° C. and folded.

Condensation of the pre-dried coating takes place under pressure at about 6% relative humidity and 140° C. and a rotation speed to 600 m/min. for 30 min. in a HT tumbler (by Thies Coesfeld in the present case).

After that, the coating process as such is completed.

The manner of any subsequent surface treatment depends on the desired appearance of the surface. In case of a surface similar to “peach skin”, i.e. a very dense, but short pile, a sueding process is carried out while a raising process is used when a somewhat longer pile is desired. Final stentering to a defined width is the last step of the process.

Results of the Light Exposure Tests (Fakra, DIN 75202):

Exposure of the Pre-Dyed Textile Substrate:

1× Fakra grade 5-6 (blue scale)

3× Fakra grade 2-3 (grey scale)

Exposure of the Final Product:

1× Fakra grade 7 (blue scale)

3× Fakra grade 3-4 (grey scale)

### Example 2

| | |
|---|---|
| Starting material: | 3-bar warp-knitted fabric |
| Guide bar 1: | 45f32T-611 flat 33.4% - Trevira |
| Guide bar 2: | 45f32T-611 flat 45.7% - Trevira |
| (alternatively: | 83f136 micrell; textured - polyester) |
| Guide bar 3: | 50f20T-610 flat 20.9% - Trevira |

All yarns are undyed.

Path of Treatment:

1. 1× pre-raising on 7 tambour cylinders

2. 1× raising and shearing

3.Dyeing with selected disperse dyes as formulated

4.Drying

The textile substrate is now ready for coating (weight per unit area 250 g/m²).

Then a composition for application was prepared by mixing the following components (all in parts by weight).

| | |
|---|---|
| Water | 90 parts |
| Tubicoat thickening agent HEC | 1.5 parts |
| Tubicoat PU 80 | 800 parts |
| Tubicoat plasticiser MV | 60 parts |
| Tubicoat foamer AOS | 40 parts |
| Tubicoat fixing agent HT | 20 parts |
| Tubicoat coagulant 24% AE | 35 parts |
| Ammonia | 3 parts |
| Pigment preparation | 7 parts |

All of the products of the “Tubicoat” series are available from CHT R. Beitlich GmbH, Tübingen, Germany.

The Following Pigments are used Depending on the Intended Hue:

PIGMATEX Gelb 2 GNA 60456

PIGMATEX Gelb K 60455

PIGMATEX Fuchsia BW 60416

PIGMATEX Marine RN 60434

PIGMATEX Braun R 60446

PIGMATEX Schwarz T 60402

The PIGMATEX pigments are available from the following supplier: SUNChemical, Bad Honnef, Deutschland.

This coating liquid, the colour of which has been adjusted (with pigments of high light-fastness), is fed into a Stork FP 3 foam processor where an instable foam having a relative density of about 300 g/l is produced. Said foam is fed directly into a closed squeegee system of the Stork Rotary Screen Coating Unit CFT.

At a pressure of 2.4 bar in the closed squeegee system and a mesh number of the screen of 25, an overall weight per unit area of (textile substrate+coating) of 270 to 350 g/m² is obtained.

After application of the coating, the article is subjected to a very brief, but intense steam treatment (about 4 sec. at 102° C.) which causes spontaneous coagulation. After coagulation, the article is dried at a temperature of 175° C. and folded.

Subsequently, a surface treatment, e.g. sueding or raising and a tumble process, as described above in Example 1, is carried out.

After that, the coating process as such is completed.

Final stentering to a defined width is the last step of the process.

Results of the Light Exposure Tests Xeno 1200 (Ford Method FLTMBO 150/02):

Exposure of the pre-dyed textile substrate: fastness grade 3

Exposure of the final product: fastness grade 4

1. A process for preparing a synthetic suede leather. comprising the steps of
(a) foaming a composition comprising an aqueous polyurethane dispersion;
(b) applying the foamed composition to a textile. substrate composed of a yarn;
(c) coagulating the polyurethane dispersion after the foamed has collapsed;
(d) drying; and
(e) condensation,
said foamed composition containing pigments during application.

2. A process according to claim 1, characterised in that the pigments are present in an amount of up to 10 wt. -% based on the total weight of the composition.

3. A process according to any of the preceding claims, characterised in that the composition contains a coagulant.

4. A process according to claim 3, characterised in that the coagulant is an acid or a chemical substance capable of generating an acid.

5. A process according to any of the preceding claims, characterised in that the composition contains a foaming agent.

6. A process according to any of the preceding claims, characterised in that the yarn has a count of 0.01 to 1.40 denier.

7. A process according to any of the preceding claims, characterised in that the fibres of the yarn consist of polyester.

8. A process according to any of the preceding claims, characterised in that the yarn is pre-dyed with disperse dyes before applying the foamed composition.

9. A process according to claim 8, characterised in that the pigments contained in the composition and the disperse dye have the same colour hue.

10. A process according to any of the claims 8 or 9, characterised in that the depth of the colouring of the yarn effected by the disperse dye is less than the colouring effected by the pigmented composition.

11. A process according to any of the preceding claims, characterised in that foaming is carried out in such a manner that a foam density of 250 to 600 g/l is obtained.

12. A process according to any of the preceding claims., characterised in that the foamed composition is applied in a closed squeegee system.

13. A process according to any of the preceding claims, characterised in that the composition is applied in such an amount that the weight per unit area is increased by 20 to 40% vis-à-vis the textile substrate.

14. A process according to any of the preceding claims, characterised in that the textile substrate is subjected to mechanical stress before, during or after the condensation phase.

15. A process according to claim 14, characterised in that the mechanical stress is applied during the condensation phase through a tumble process.

16. A synthetic suede leather obtainable according to the process of any of the preceding claims.

17. The use of the synthetic suede leather according to claim 16 as a cover in automotive, furniture or upholstery applications or as outer garments.
